(19) United States
(12) Patent Application Publication
(10) Pub. No.: US 2022/0188883 A1
(43) Pub. Date: Jun. 16, 2022

(54) SYSTEMS, DEVICES, AND METHODS FOR ANALYSIS AND AGGREGATION OF DATA FROM DISPARATE DATA PLATFORMS

(71) Applicant: OCTANE 11, INC., NEW YORK, NY (US)

(72) Inventor: Daniel Lawrence Rosenberg, New York, NY (US)

(21) Appl. No.: 17/644,207

(22) Filed: Dec. 14, 2021

Related U.S. Application Data
(60) Provisional application No. 63/124,992, filed on Dec. 14, 2020.

(51) Int. Cl. G06Q 30/02

(52) U.S. Cl. CPC G06Q 30/0282; G06Q 30/0201

(57) ABSTRACT

A system and method for analysis and aggregation of data from disparate data platforms is disclosed. The system may generate a company profile by receiving information from a plurality of sources, mapping the information to a common data model including each of a data source, a topic, and a company, and associating data from the plurality of sources to companies based on the affiliation of the subjects of the data. In addition to data source and company, the system may identify a topic for ingested data and use the aggregated information to create company profiles. The system may use company profiles to target companies for business interaction, monitoring the plurality of sources for evidence of the business interaction, evaluating the effectiveness of the business interaction, and updating the company profile.

### BACKGROUND

The present application relates to systems, devices, and methods for analysis and aggregation of data from disparate data platforms.

### SUMMARY

Business to Business (B2B) marketing faces many technical challenges different from Business to Consumer (B2C) marketing. The unique, unmet challenges facing business-to-business marketing require creative technical solutions, such as those described herein.

In particular, in some embodiments, the systems, devices, and methods described herein may provide novel technological solutions for dynamic aggregation of data for purposes such as digital advertising, sales, contracts, and/or other business activities. Data may relate to paid, owned, or earned impressions, and/or the impact of digital advertising. Some embodiments may trace revenue streams resulting from advertising and/or marketing activities. Some embodiments may use user information-based analysis and optimization of targeted advertising and the resulting sales and impacts and/or the like from disparate data sources or platforms. Some embodiments may use different communication protocols and/or data structures. In some embodiments, the systems, devices, and methods can analyze such data in substantially real time to generate guidance for targeted digital advertising methods and strategies, such as for example business-to-business and/or business-to-consumer targeted digital advertising.

In some embodiments, a computer system may comprise one or more computers that generate one or more company profiles by receiving information from a plurality of sources, wherein each of the plurality of sources comprises data associated with a plurality of individuals. The information may come from multiple data sources which may have a variety of different data models. This information from the plurality of sources may be mapped to a common data model where each datapoint includes a data source, a topic, and a company. The system may associate topics with data using a database of topics available to the system. The computer system may affiliate individuals with companies and have a database of companies available to the system. The aggregated information from the data sources based on the affiliated company may contribute to the profile of that company.

In some embodiments, the system may use company profiles to target companies by receiving a company as a target for a business interaction, identifying a particular topic as a relevant factor for targeting the first company and incorporating information from the company profile into the company's business interaction. The system may monitor the plurality of sources for evidence of the business interaction with a company based on the company profile and may evaluate the effectiveness of the business interaction based on the company profile and on the evidence of the business interaction. The system may update company profiles based on evidence of the business interaction with companies.

In some embodiments, the computer system may change the mapping of each individual to a company over time because a particular individual may be affiliated with one company at one time and may be affiliated with a second company at a later time. The system may perform the mapping of individuals to companies using an artificial intelligence based at least in part on the information from the plurality of sources. Further, the computer system may associate topics to data using an artificial intelligence based at least in part on the information from the plurality of sources. The system may receive a topic as relevant to the purpose of the business interaction and the artificial intelligence may identify the company as the target for business interaction. The computer system may further comprise an artificial intelligence able to predict a likelihood the business interaction with a company will be effective based at least in part on the company profile and a set of historical data about the company. The plurality of data sources may comprise data items from a plurality of paid, owned, and earned marketing sources, as well as product, service, human resources, and finance sources.

In some embodiments, the computer system may comprise an application programming interface allowing external programs to access the information from the plurality of sources in the common data model. The computer system may further comprise a user interface to display the information from the plurality of sources in the common data model and generate reports from company profiles and the effectiveness of business interaction. Other reports may compare a plurality of company profiles and summarize the data items from the plurality of paid, owned, and earned marketing sources as well as product, service, human resources, and finance sources.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

A better understanding of the devices, systems, and methods described herein will be appreciated upon reference to the following description in conjunction with the accompanying drawings, wherein:

FIG. 1 illustrates features of one or more embodiments of systems regarding modeling, campaigns, and/or impact measurement;

FIG. 2 illustrates three stages of consideration, according to some embodiments, regarding strategy, campaigns, and/or analytics, including lift measurement;

FIG. 3 illustrates steps used in one or more embodiments to analyze data;

FIG. 4 illustrates information and reports available in one or more embodiments;

FIG. 5 illustrates features of a report from one or more embodiments;

FIG. 6 illustrates features of a report from one or more embodiments;

FIG. 7 illustrates features of a report from one or more embodiments;

FIG. 8 illustrates features of a report from one or more embodiments;

FIG. 9 illustrates potential categories for consideration in one or more embodiments;

FIG. 10 illustrates a worksheet of data found in one or more embodiments for an example client;

FIG. 11 illustrates possible data used in some embodiments;

FIG. 12 illustrates possible elements of one or more embodiments;

FIG. 13 illustrates three characteristics of a data source, a topic, and a company in some embodiments;

FIG. 14 illustrates a role of artificial intelligence to enhance system operation according to some embodiments;

FIG. 15 illustrates the conversion to, and benefits of, a common data model according to some embodiments;

FIG. 16 illustrates a flowchart of system operation, according to some embodiments;

FIG. 17 illustrates a role of a common data model and artificial intelligence in facilitating sales according to some embodiments; and

FIG. 18 is a block diagram depicting an embodiment(s) of a computer hardware system configured to run software for implementing one or more embodiments of systems, methods, and devices for analysis and aggregation of data from disparate data platforms.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and includes other uses of the inventions and obvious modifications and equivalents thereof. Embodiments of the inventions are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

The present application relates to systems, devices, and methods for analysis and aggregation of data from disparate data platforms.

Business-to-business (B2B) marketing faces many technical challenges different from business-to-consumer (B2C) marketing. The unique, unmet challenges facing business-to-business marketing require creative technical solutions, such as those described herein.

In particular, in some embodiments, the systems, devices, and methods described herein may relate to dynamic aggregation of data for purposes such as digital advertising, sales, contracts, and/or other business activities. Data may relate to paid, owned, or earned impressions. Data may relate to the impact of digital advertising, which may be a form of paid impressions. Some embodiments may trace revenue streams resulting from advertising and/or marketing activities. Some embodiments may use user information-based analysis and optimization of targeted advertising and the resulting sales and impacts and/or the like from disparate data sources or platforms. Some embodiments may use different communication protocols and/or data structures. In some embodiments the systems, devices, and methods can analyze such data in substantially real time to generate guidance for targeted digital advertising methods and strategies, such as for example business-to-business and/or business-to-consumer targeted digital advertising.

Advertising may occur in one or any of separate channels. Channels may include digital web advertisements, direct email, digital billboards, web site pages, printed advertisements, printed mail, social media messaging in sites such as twitter, Facebook, LinkedIn, or others. Some of these communications are paid for and are therefore referred to as “paid” herein. Some are displayed on media where a business has control over the channel and/or its content, potentially including email and messages on corporate web sites, and are therefore referred to as “owned.” Marketing that involves the uncompensated promotion actions of others, such as third-party posts on social media, press articles and/or other awareness or action promoting messages by uncompensated third parties, is referred to as “earned.”

In some embodiments, the system may generate a multi-channel digital marketing campaign. As used herein, the term “MarTech” may refer to Marketing Technology, “AdTech” may refer to Advertising Technology, “B2B” may refer to Business to Business, “B2C” may refer to Business to Consumer, “CRM” may refer to Customer Relationship Management, “PII” may refer to Personally Identifying Information, “PV” may refer to Post View, such as where an action happens after an ad has been viewed, and “PC” may refer to Post Click, such as where an action happens after an ad has been clicked.

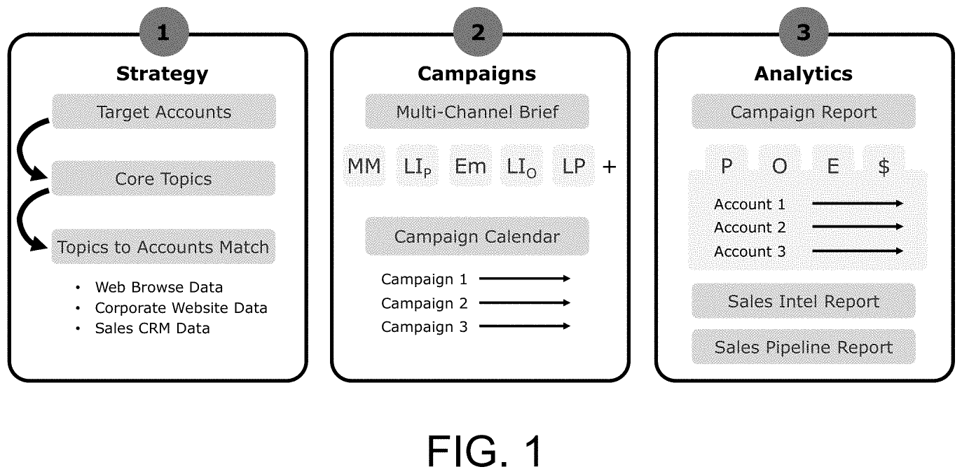

In some embodiments, the systems, devices, and methods described herein provide software and/or services that may make it easier for business-to-business marketers to manage and measure their digital marketing activities across multiple screens and touchpoints. FIG. 1 illustrates some of the elements used in some system embodiments.

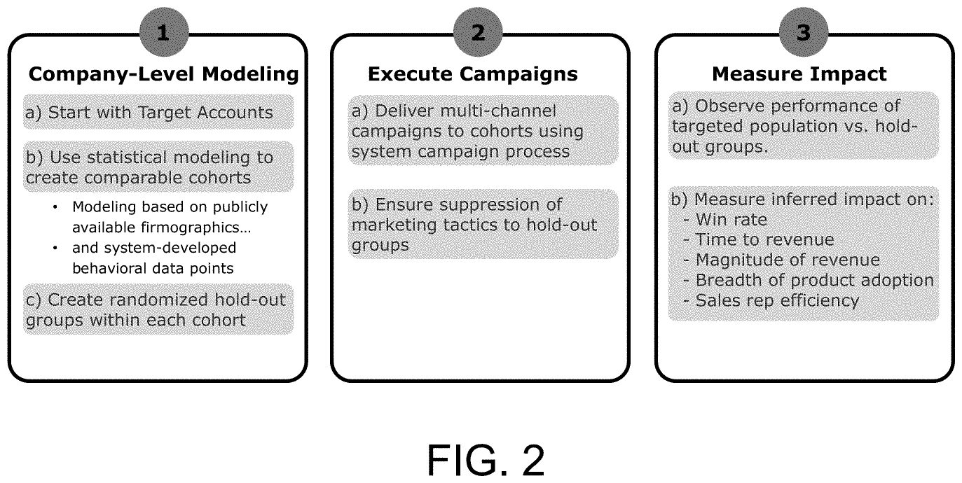

FIG. 2 shows three stages of consideration according to some embodiments: company level modeling, execution of campaigns, and measuring the impact of campaigns. Company-level modeling may start with target accounts, use statistical modeling to create comparable cohorts, and create randomized hold-out groups within each cohort. The statistical modeling may be based on publicly available firmographics and/or system-developed behavioral data points. Some data may come from “walled gardens,” which are closed ecosystems controlled by a single entity. Campaign execution may deliver multi-channel campaigns to cohorts using system campaign process and may ensure suppression of marketing tactics to hold-out groups. Measuring impact may be based on observing the performance of targeted population compared to hold-out groups. Further inference of impact may come from: win rate, time to revenue, magnitude of revenue, breadth of product adoption, and/or sales person efficiency.

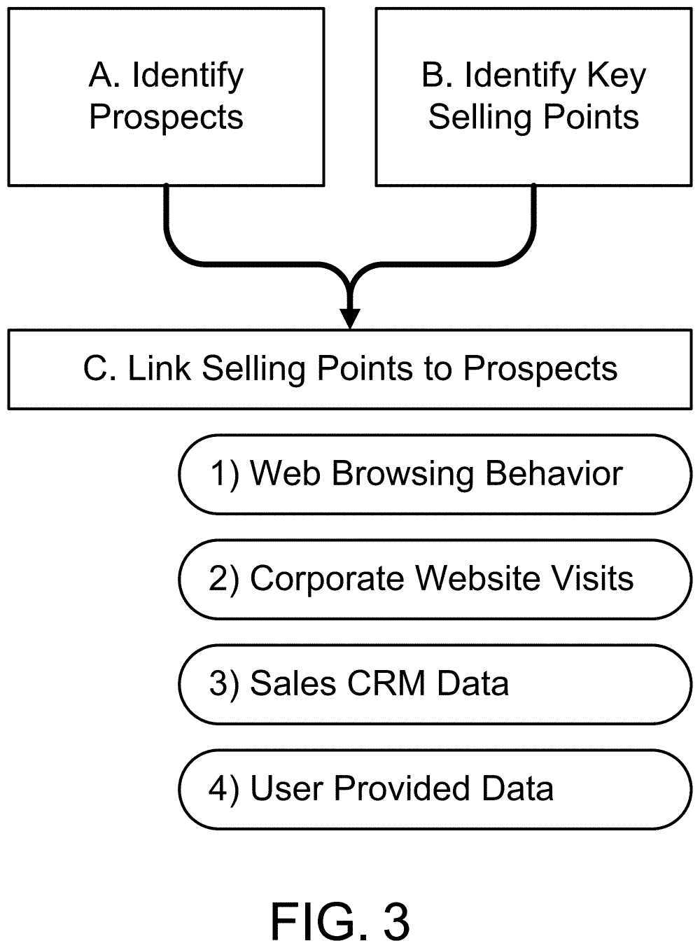

In some embodiments, the systems, devices, and methods described herein may provide one or more of the following:
(1) Strategy: Help clients to (a) identify their top prospects, (b) identify their key selling points, and/or (c) identify which selling points are likely important for particular prospects as shown in FIG. 3.
   For part (a), the system may integrate third party tools that can generate a list of target companies based on “firmographics” (for example, size, location, industry, IT products in use, and so forth).
   Likewise, for part (b), the system can introduce and/or manage third party tools to help clients more clearly understand the topics that are most interesting to their best customers.
   For part (c), the system may use data including the following data sources (among others):
      (i) Web Browsing Behavior may include the extent to which employees from a particular company are browsing web pages covering a particular topic.
      (ii) Corporate Website Visits. For example, site pixels may capture data on client websites to determine which topics clients may be interested in.
      (iii) Sales CRM Data. The system may connect to sales CRM tools, to potentially leverage the rich data that is already collected by sales personnel on clients' interests, incumbent products, other products under consideration, complementary products in use (from the advertiser or other partners), upcoming renewal deadlines, and/or others.
      (iv) User provided data. The system may consider directly entered information from clients not specifically enumerated in another source.
(2) Campaigns: In some embodiments, the system can help clients to execute campaigns targeting the companies with the content identified in (1) Strategy, across any/all digital screens including the open web, walled gardens, email, Programmatic Print, AdvancedTV, Digital Out of Home, public relations activations (PR activations), and so forth. PR Activations may include articles, interviews, press mentions, and/or other materials that are commonly, but not always, coordinated with specific marketing campaigns. For example, advertising may be scheduled to coincide with a press article or interview. The system may connect and link these seemingly coincidental events which may be tracked and measured together. The system may also leverage third party company targeting data in the delivery of paid ads on the open web and/or walled gardens or others.

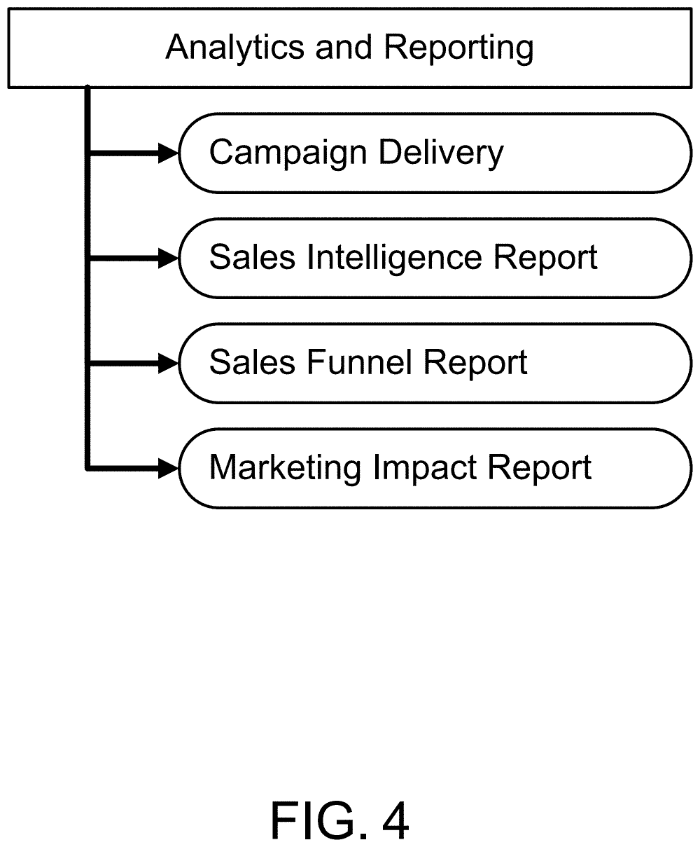

In some embodiments, functions are built on top of standard workflow tools, with customizations to mesh their workflow tool into the system and to streamline campaign planning, approvals, and set-up processes for the specific needs of business-to-business multi-channel campaigns. FIG. 4 shows elements of analytics and reporting, according to some embodiments.
(3) Analytics: The system may help clients to track delivery of the paid, owned and earned marketing activities listed above. In some embodiments, a simple dashboard shows these activities at the company-level and creates actionable insights.
   (a) Campaign Delivery: In some embodiments, reports show any/all paid, owned, and earned activity, possibly alongside sales activity (for example revenue, pipeline, and so forth.), at any level, including at the company-level. This data can be filtered by campaign, timeframe, region, salesperson, stage of funnel, industry, revenue opportunity, and so forth., so that it is of maximum value to company executives or others.
   (b) Sales Intelligence Report: In some embodiments, reports capture the “feedback” coming from prospects' interaction with market activities (for example ad clicks, emails opened, social posts liked) to provide intelligence on which clients are showing the most interest in the products and on which messages or dimensions of the products, so that the sales team can prioritize its outreach and tailor its conversations.
   (c) Sales Funnel Report: In some embodiments, this report makes it easier to visualize how marketing efforts interact with sales activities to drive specific revenue targets. The report may connect revenue targets, sales team close rates, inside sales close rates and marketing lead productivity to create a full picture of marketing productivity.
   (d) Marketing Impact Report: In some embodiments, a report may show approximate “lift measurement” or A/B testing reports but tailored for business-to-business marketers. This may be achieved by analyzing the advertiser's target customer list using look-alike models to break the customer list into a number of cohorts that have substantially similar attributes. In some embodiments, suppressed marketing activities for a small portion of each cohort (a “hold out group”) may relate the performance of the hold-out group compared to the marketed-to group in each cohort across time to close, cost to close, level of revenue, retention, and so forth.

Generally speaking, advertisement exchange products are used by ads, digital ads, on phones and laptops, and other kinds of digital screens, primarily confined to advertising. This is referred to as “paid” within the framework of some embodiments described herein which can also include “owned” and “earned”. In some embodiments, paid includes advertising. Owned can include things such as an owned website, an owned or managed call center, or other interfaces completely under one's control. Earned can include interfaces such as public relations (PR) and social media or uncontrolled, possibly external, influence.

Regarding the paid portion, certain advertisement exchanges may support business to consumer marketing. However, the business-to-business portion typically needs more capabilities targeted at business-to-business marketing because it is a different use case. In contrast to business-to-consumer marketing, business-to-business marketers do not typically need to reach millions of people, but rather need to reach a targeted list of people who make high price decisions. Targeting of decision makers can impose unique technical problems, such as the need to reach an entire buying committee or reaching the few strategic decision makers in a large organization.

In some embodiments, marketers may have a page on a website called a landing page, digital ads, emails, social media posts, including sites such as LinkedIn, and/or email signatures. As another example, digital out of home (DOOH), can include outdoor billboards. In some embodiments, the system can be configured to work in conjunction with various tools from many different companies. In some embodiments, the system can be configured to connect different third-party tools and the system's own additions. For example, in some embodiments, the system's own additions can include a tool with a web front end that customers can interact with. In some embodiments, the system can also leverage the integrated data to perform calculations and executions without manual user inputs. In some embodiments, the system can also push integrated data to other systems.

In some embodiments, the system receives a list of target companies from a user. For example, a client or user may have 10,000 companies that the client currently sells to.

In some embodiments, the next step is separating a list of core topics, such as the selling points of a product. In some embodiments, the system may turn these selling points into keywords. In some embodiments, the system uses data to match the companies to the topics to end up with a list of companies, with each company linked to keywords against it. The keywords can change and may get updated in real time. The system can make these dynamic and potentially real time linkages and changes using artificial intelligence (AI), rules, and/or other logic.

In some embodiments, the system takes advantage of different data sources. Data may come from various partners according to the collection and sharing policies of the organizations involved. One possible data source is web browsing behavior. The web browsing behavior of the people who work at target companies may provide valuable insight. In some embodiments, even more beneficial can be web browsing behavior of people who work in the departments that may potentially buy product at those companies. In some embodiments, the system is configured to analyze and/or utilize browsing behavior for business-to-consumer marketing. For instance, if a consumer goes to a website and puts a sweater into his or her shopping cart at a company, the consumer may see that sweater repeatedly, on many other websites the consumer visits. In some embodiments, systems, devices, and methods herein can analyze and/or utilize browsing behavior for business-to-business marketing. While business-to-consumer may target individuals, business-to-business may gain greater advantages by targeting groups of individuals based on their collective character or company affiliation.

In some embodiments data comes from additional sources. For example, in some embodiments, the system can be configured to analyze and/or utilize the corporate web site, which can be another variation where instead of tracking the behavior of users across the entire web, tracking is based on visits to your own corporate website. Additionally, in some embodiments, the system can be configured to analyze and/or utilize user activity, for example through a Data Management Platform (DMP). A DMP may be a database that tracks web-based user activity on a website or in digital ads on the open web. This data is usually used to create groups of users for ad targeting. The system may connect to an existing DMP.

In some embodiments, the system can be configured to analyze and/or utilize sales CRM data. Sales teams may capture data in notes or other records of a sales meeting. Such notes and records may be typed up and stored in a computer system. For instance, they may write that the company or the prospect cared about X, did not care about Y, they are using this competitor, they are considering this other company, they have tried something in the past which failed, or many others. Data may also be more automated such as records that an existing customer has their contract due for renewal in 90 days. Many other types of live data may be captured in the CRM system. However, such data may be intended for the sales team rather than marketing. For example, when a sales team prepares to return for another meeting, they can look at their notes and use that to prepare their presentation for the next meeting. In some embodiments, the system may incorporate that data, map it to topics and/or other data, and/or tag accounts with the keyword topics.

In some embodiments, clients provide access to the sales CRM data. Such access may begin when onboarding a client and they provide the system with credentials to access the CRM data. The system may pull data from the client's sales CRM data into the system's database. That data may be transformed, mapped, and operated on.

In some embodiments, these disparate data sources are merged to create greater insight. Merging may involve combining any or all of web browsing behavior, the corporate database, and the sales CRM into a unified data set at the company level. This much richer set of keywords may relate to particular companies.

In some embodiments, clients may be advertisers. Those clients, that are advertisers, are advertising to other businesses. For example, the web browsing data can be data from the advertiser's website. When people, and perhaps the companies they represent, come to the client website to look at different product offerings, or solutions or events, they can essentially be seen as raising their hand to indicate interest in one of those topics. The system may monitor these actions and then blend that knowledge with other data to enhance business to business marketing.

In some embodiments, the sales CRM data also comes from the client. In some cases, the CRM data is generated by their sales team. CRM data is often extremely rich data, though often smaller in volume, but with a high signal to noise ratio. That can add value to the system and additional data sets may be added to that. The system may map topics important to clients through computation and/or comparisons between data sets.

In some embodiments, additional browse behavior may come from a bidding process for buying advertising resources. For example, some advertisers' business can involve bidding on advertising impressions and may have a volume of millions of impressions per second. These large volumes of browse behavior are probably tied to a person. The system may take the next step of rolling up that signal from multiple people into a business. This aggregation of data related to individuals into representative needs and interests of a business may lead to marketing leads and resulting sales previously unattainable.

In some embodiments, data may come not from the client's own resources, but may be purchased from other data aggregators. Other companies may aggregate website browsing information that may be one input to the system. Other companies may have similar data but related to other industries. Any, or all, of these external data sources may be combined individually or collectively in the system. In some embodiments, the system creates a specific signal for targeted accounts based on these aggregate data streams that are based on unique individuals within their targeted accounts.

In some embodiments, the system can be configured to identify one or more decision makers, such as purchase decisions, within a certain company. In some embodiments, identifying decision makers on an account is not necessary. In some cases, it may limit the scale of advertising targets. In some cases, knowing the individuals in a department who are likely part of a decision-making committee can be far more valuable than knowing the individual responsible for the decision. The more valuable target can be the multitude of people within a company that may be relevant to a decision.

In some embodiments, the system may adjust as the collection of individuals comprising a business changes over time. In particular, the system can map the individuals to companies in a way that changes over time. In some embodiments, the system can create a graph of the migration of people between companies to ensure current and valid aggregations of individuals. In some embodiments, such changes may use IP addresses. For instance, the IP address for the Wi-Fi in an office likely belongs to the company that owns the office. People may use this network every day and the cookies that are seen on that IP address are likely to be employees of this company, or somehow affiliated with the company. In some embodiments, this is a way people are tracked by the system. And such tracking can reveal and resolve changes in corporate membership over time.

In some embodiments, the system may conclude stage one with a list of the target companies and each one may have a set of keywords. The keywords can constantly refresh, providing almost real time understanding of the target companies and potentially providing awareness of the topics of interests for those target accounts. Such data may be stored in a database.

In some embodiments, the system may comprise an approach of products, solutions, compliments, competitors, industries, and events. For example, an advertising or marketing company may have a product, product X. If someone is looking for product X, the system may recognize the user is interested in product X, and the system may market to them on behalf of the advertising company. Similarly, a company may be looking for something about media quality, an upcoming renewal, or may be working with a complementary vendor. In such a case, in some embodiments, the system could suggest advertising that the client product works with that vendor. In some embodiments, the system can identify a company working with a competitive vendor and/or suggest sending ads that show why the client's product is superior to that competitive vendor.

In some embodiments, clients may want to go in reverse. For example, a client may have a list of products to sell and want to find people who care about that product. Alternately, a client may know their customers and want to know what they care about, and what kind of content are they browsing for. In some embodiments, the system may accommodate either of these alternatives and provide optimal marketing material within the client's parameters.

In some embodiments, the system may employ social data. For example, that could include data from people's browsing behavior, or the content that they are consuming on a website like LinkedIn or Twitter. In these cases, the system may roll data up into businesses.

In some embodiments, the roll up of individuals can increase the signal attributable to a company. For example, a marketing company may team up with a company that will issue an advertisement formatted as a press release and then put it out on all the wires. In some embodiments, the marketer may embed tracking into some press releases to feed data into the system. When people engage with those press releases, they essentially raise their hand to say that they are interested in this topic. The system may “amplify” that message by showing ads to those people based on the topic they are interested in. One of the challenges can be trying to find individuals who have engaged with a press release. Engagement may include reading or other actions. It may be small. But when the system infers those people are part of companies, and if that press release was about a business product, the system can then deduce that the company may be interested in that product. In other words, in some embodiments, the system is not trying to find one person, but the system is rather finding a multitude of people in their buying department, which can be rolled up to the company level like an amplification.

In some embodiments, the system may use an earned media data source. Earned media relates to media exposure under the control of others. This too may be appended to the multi-channel data to an account level.

In some embodiments, the system software may be sold as on premises software and in other cases it may be hosted by another third party, as a software service. In the service model, clients may come in, swipe their credit card, upload 100 clients, 1,000 clients, pick a number of topics, put in their sales CRM credentials, and additional details that the system requires. Then, in some embodiments, the system can populate their list with related data.

In some embodiments, the system uses a campaign workflow component. The system may take information on the companies and determine how to reach them. One of the insights for business-to-business marketing can be that the system is reaching small audiences. However, when the system does the work of creating an ad campaign, it may not unnecessarily limit itself to this small audience. Various embodiments may include one or more of several elements. For example, one of them can be advertising on the open web. Another example can be LinkedIn, a medium to target businesspeople, and LinkedIn is paid. Email may be a component. LinkedIn organic, separate from LinkedIn paid, may be a page post by companies that draws likes and shares, which may be considered earned. Another element can be a landing page (LP). A landing page may be used to provide additional information about the subject of a campaign and to obtain additional information about interested users, such as collecting information when users visit a landing page. In some embodiments, the system's marketing material has a call to action; to get people to go to a landing page. A landing page may contain what you want to show them. The landing page may also capture their information and tag them.

In some embodiments, the system can be configured to utilize one or more additional pieces of advertising, such as for instance, digital out of home billboards on the street, audio ads, video ads, and/or direct mail into homes. The system can start adding these on. For example, in some embodiments, the system may have a number of simultaneous activities combined into coherent campaigns to manage and make sense of it all. In some embodiments, for every topic the system may have a table of product descriptions and/or there could be a campaign for each one. In some embodiments, campaigns may be refreshing all the time and/or periodically. In some embodiments, the system may manage campaigns that are always on. The activities of the system in other stages may subscribe companies and the people at those companies to one or more pieces of content.

In some embodiments the system may gather event data. Events may be related to a topic. For instance, for some events, somebody's interest in the event may show a specific interest. In some cases, promoting that event may become the creative message that goes into some forms of advertising to serve to the people who have indicated interest in that topic. In some embodiments, conference information, and data such as who has visited a booth, may generate data that can be utilized by the system.

In some embodiments, campaign efforts may be an ongoing real time event. Campaigns may cover any single, or a multitude of topics. Campaigns may be continual and/or evergreen. In some embodiments, the system may manage the companies and the people at those companies to subscribe or not subscribe and/or how to target them, for example based on their behavior in real time.

In some embodiments, targets may specify a department or a role within the company. For example, someone may propose sending laptop advertisements to the director of IT rather than an assistant. While that can be done in some embodiments, that may reveal a temptation to use all the data that's available, which can be one of the traps that a lot of companies and marketers, especially business-to-business marketers can get into. In other words, in some cases, the target audience becomes so small to have become meaningless without scale. They are trying to find an individual, which can end up being unhelpful. As such, in some embodiments, it can be more effective to send out a campaign directed to all the people in the department to scale better. In reality, all the people that surround the executive leadership can be important, and the system can make sure the right people are targeted.

Some embodiments set up a campaign across all or some of the different channels. The system may take the targeting data from first step strategy components and may produce keywords. The system may take these keywords and determine companies interested in these topics.

In some embodiments, clients may target specific companies in addition to any selected by the system algorithms. Other specific requirements could be by geography or any other parameter. For example, a whole campaign may target any companies interested in identified topics that are in Australia. The campaign may further filter to target the people in the marketing department and/or the chief executive level, sometimes called the C level. Additionally, the customer may demand that regardless of what the system parameters say, a specific company should be targeted.

In some embodiments, this campaign piece is built on top of the system components and incorporates other workflow tools. It may be customized to exactly what is wanted, which can be referred to as the campaigns piece.

In some embodiments, the system analytics component reports insight into the results of strategy and campaigns. The campaign report may show the delivery of the campaigns, the paid, the owned, and/or the earned, and/or the actual revenue impact of those campaigns. Such reports may be at the account level. The system, in some embodiments, provides insight into sales and links those sales to marketing efforts which are the core of the business-to-business process. Management may care about those details because sales activity may be denominated in revenue, customers, pipeline, time to close, who the salespeople are, and so forth. Every executive meeting can have a sales team report of this type. In some embodiments, the system may ensure that marketing and sales are connected. In some embodiments, the system's management of strategy and/or campaigns enables the system to connect those actions to revenue. The system can therefore display the marketing information in a way that is relevant to the sales team, and therefore to the CEO, to the board, and to the people who are managing the business.

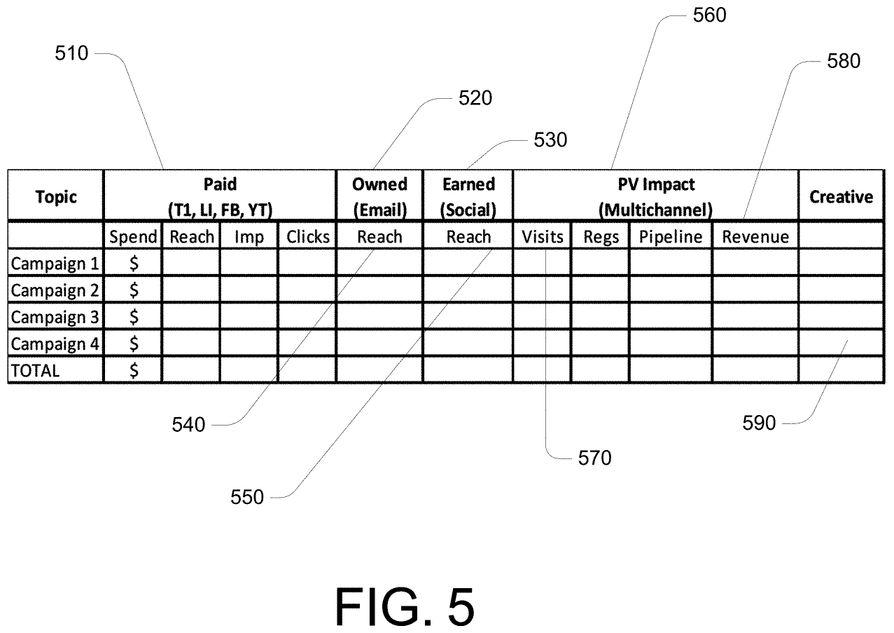

FIG. 5 illustrates a campaign management report, according to some embodiments. The report may include filters to limit the displayed data and/or may include filters to limit the underlying data aggregated for the report. Filters may relate to time, company, region, or any other characteristic the system considers in analysis or aggregation of data. Example time filters may include campaign to date, month to date, last seven days, or another fixed period. Filters may be applied singly, in combination, or not at all.

Reports may display paid 510 data (e.g., as described above). Advertising may occur in one or any of separate channels. Some communications are paid for. Reports may display owned 520 data (e.g., as described above). Some are displayed on media where a business has control over the channel and/or its content, potentially including email and messages on corporate web sites, and are therefore referred to as “owned.” In some embodiments, owned 520 includes email only. One exemplary source could be a marketing automation or email management platform. Reports may display earned 530 data (e.g., as described above). Marketing that involves the uncompensated promotion actions of others, such as third-party posts on social media, press articles and/or other awareness or action promoting messages by uncompensated third parties, is referred to as “earned.” In some embodiments, earned 530 includes LinkedIn, Facebook, Instagram, and/or Twitter. Email reach 540 is the number of email addresses targeted at least once. Earned reach 550 is the number of unique viewers or unique visitors (UV) that viewed a post from the campaign. “T1” is a brand name for a type of demand side platform (DSP); LI may be LinkedIn; FB may be Facebook; YT may be YouTube. Any of the foregoing companies may be a source of data in some embodiments. Other sources or reports are possible in various embodiments.

Reports may include post view (PV) impact 560 data. Such post view impact could include a visitor providing their personal contact information, providing other PII, or signing up for an event or to download an asset. Reports may include visit 570 data, where visits refer to a person or customer electronically visiting the target site. Reports may include revenue 580 data. Alternative information displayed on a report could include pipeline revenue from sales CRM, pipeline revenue from all companies targeted in the campaign, pipeline revenue from all companies that were reached, pipeline revenue from companies reached after the campaign went live, change in pipeline revenue from companies reached after the campaign went live, or other features or metrics. Reports may include links to a creative staging tool 590. Such a staging tool could offer further customization and/or analysis of data and results.

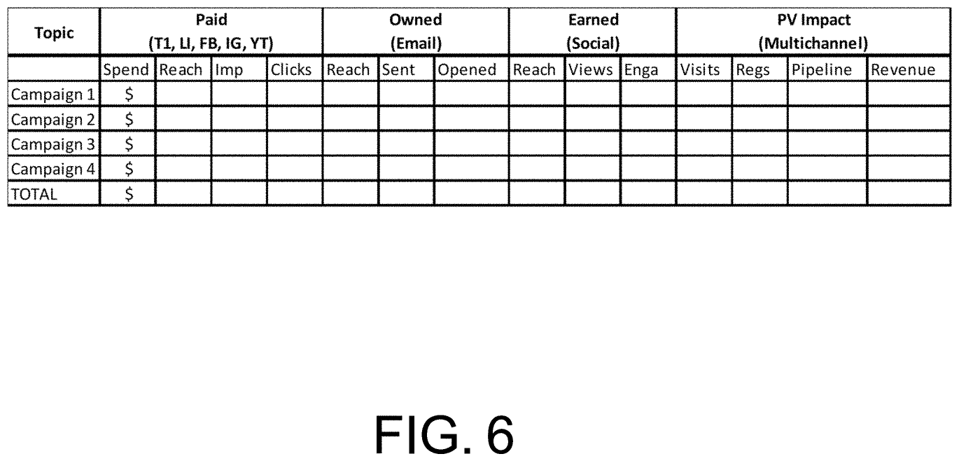

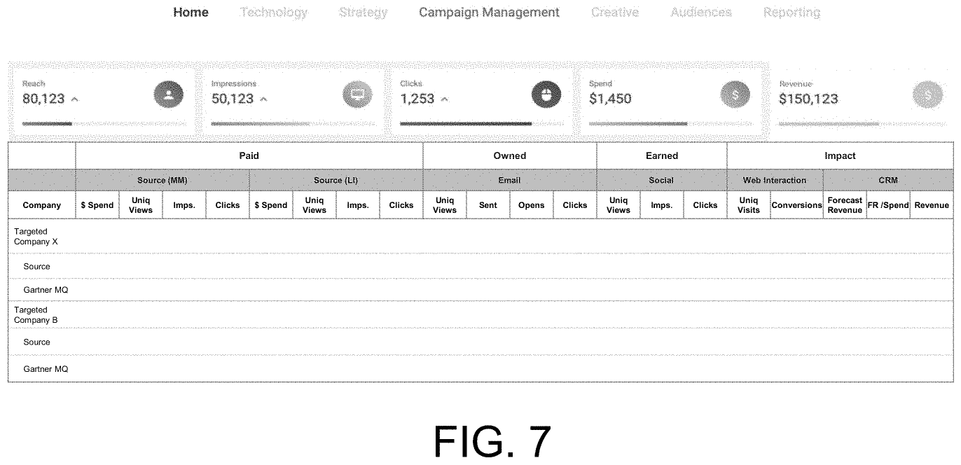

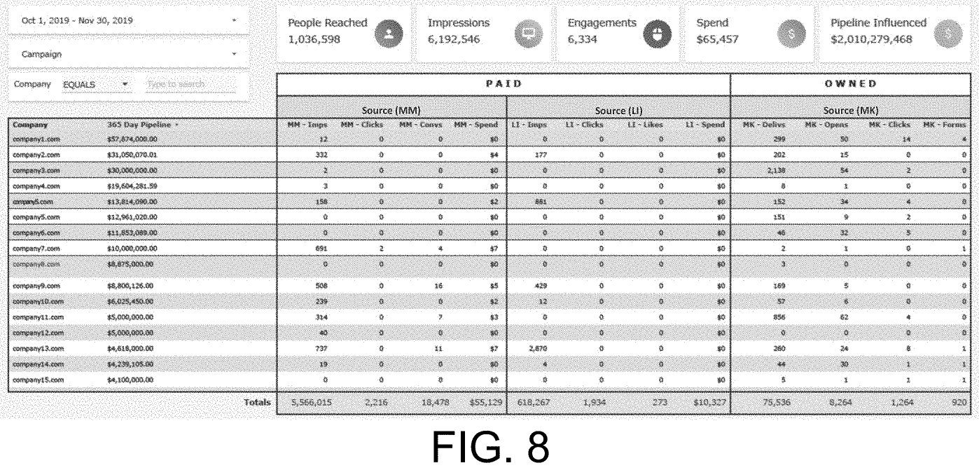

For a campaign, reports may open and show detail by company. For example, the report may show “Top 10” (by revenue for instance) and then “all others” and could also show the people and companies reached. FIG. 6 shows a more detailed report according to some embodiments. FIG. 7 shows an alternate embodiment of the campaign report that also includes aggregated data for the entire table. FIG. 8 shows a report embodiment of company interactions via paid 510 and owned 520 channels according to some embodiments.

As used herein, the acronym POE may stand for paid 510, and owned 520, and earned 530. It may include the paid ads that come from online advertisers or alternatives including LinkedIn, Facebook, Instagram, and/or others. The owned 520 may include the company's website and/or the company's email. Earned 530 could include social page posts, interactions with press articles, tweets, and other social media. In some embodiments, the system may connect those to sales data.

In some embodiments, reports may show aggregate expenses for companies across paid 510, owned 520, and earned 530 categories, as well as resulting sales information. Reports may include any combination or filtered subset of these or other categories. In the example report in FIG. 8, the first column lists companies and the 365-day pipeline of anticipated revenue. This report happens to be in the months of October and November 2019. This report is for a given campaign, but other reports could include multiple campaigns aggregated. This report is sorted by 365-day pipeline revenue. The report could also be sorted by any other column.

FIG. 8 shows two columns under the paid 510 category related to impressions. Impressions could mean banner ads, video ads, or some other delivered ad. Clicks can be considered responses to ads. A conversion can be a customer arriving at a landing page or other destination. The content of the columns under the paid 510 columns lists the quantity of impressions, clicks, conversions, likes or other measures of actions combined with the spend amount to acquire those impressions, clicks or conversions.

In some cases, paid 510 services charge by impressions, or clicks, or perhaps other measures. In some embodiments, the system is agnostic toward the fee model paid for services used and can work with any of the models.

In some embodiments, owned 520 refers to the marking channels that are under the advertiser's control. These may include any or all of a web site, an email system (such as direct email advertising), chatbots, webinars, or others under the control of the company. In the example report in FIG. 8, a marketing automation or email management platform may provide the measurement service of the company-owned email advertising channels. That service could determine how many emails were sent out, how many emails were read, how many clicks came from those emails, and/or how many customers interacted with forms on a website to get more information.

In some embodiments, reports will also list earned 530 information as another column. As an example, it could be LinkedIn earned, different from LinkedIn paid that is already displayed on FIG. 8. There could also be columns for Twitter, or Facebook, or any other platform where third parties could provide advertising benefits. These social media actions can be referred to as earned because these exposures were not paid for. When people's posts result in likes and shares, those actions have advertising benefits but no direct costs. This type of viral social media may have great benefits despite not being paid for and is therefore referred to as earned 530. In some embodiments, the system connects social media handles to companies and monitors the results. Looking for an individual user can be difficult. But, in some embodiments, having the system look for everyone at the company potentially grows the chances of success many fold. For instance, if two people said something positive on Twitter, that can be aggregated. The system can aggregate that on a chart that could show two Twitter signals in a month.

In some embodiments, the system can correlate such earned 530 impressions to ad impressions made to a targeted group 1650. The system can add up these individual bits of signal, potentially showing a mosaic of interest. A single channel may have less signal. In some embodiments, the system rolls up events to the company level. That can give more material to work with and when the system rolls up to the company level it can let the system connect across the different paid 510, owned 520, and earned 530 touch points.

In some embodiments, the system may connect advertising data to sales and/or CRM data. At the company level, the system can pull in and map data from sales force data and/or CRM, which is where sales activity is typically tracked. That can allow comparisons to the sales pipeline at a company. By comparing different time frames, changes may be correlated to advertising and/or marketing activity. Data can be tied into the CRM system. In some embodiments, because CRM is tracking how many times people have called or been called, the system can use the CRM data to flag the significance of a client call. The system can potentially correlate that incoming phone call to the impressions the system made to that group of people in that department.

In some embodiments, reports may include efficacy measurements. The system may be connecting the dots and making it easier to surface the data. The layout of a report may include the working parts of the campaign report. That report may show delivery and/or allow filtering and/or sorting by the amount of revenue, by region, and/or by salesperson. That may be in some embodiments of the campaign report.

Some embodiments may include a sales intelligence report. The system could allow the report to be sorted by any of the interaction columns. The system can inform the sales team, “the company that you're selling to is interacting with our ads and our emails and our social posts about this topic. Now would be a good time to call them because they're showing interest through our media and marketing.” In some embodiments, the marketing is not just a broadcast but is rather two-way. The system can create a feedback loop which creates sales intelligence, which can be a second report according to some embodiments.

Some embodiments can be configured to generate a pipeline report. A pipeline report can be another way to show data beneficial to the sales team. In some embodiments, the system may do the efficacy measurement based on a variation of AB testing and the hold out groups whose different treatment can by analyzed. The system can take millions of users and hold back a statistically significant group and then compare results between groups. The system can do that at a business level for business-to-business marketing comparison. In some embodiments, the system may use lookalike modeling to identify a group of top customers, then the system may do some lookalike modeling to identify other companies similar to the initial set of companies. That expanded list of companies may be good prospects based on firmographics. In some embodiments, the system may identify such similar companies using where is the company located, the size or amount of the revenue, the industry, and/or another measure. Other characteristics could include products that they have, or other ways that they do marketing, or their marketing budget. In some embodiments, the system can take an existing pool of targets, which may already be quite large, and then model those to break them into cohorts of companies that are similar. The system can take a group of 100,000 companies, for example, and break it down into pods, or cohorts, of 10,000 each. The system can hold out a group of 10 percent, for example, and then market to those other groups the base system message but hold out the 10 percent for alternate treatment. The system may track the unexposed hold-out group and then track in sales CRM the behavior of those companies from amount of revenue, revenue velocity, renewal rates, and/or any other business-to-business metrics.

In some embodiments, the categories, groupings, and cohort/or creation may be automated by the system to let the machine figure it all out. Variables can be any corporate measure. It can include any or all of the following: industry SIC code, address, zip code, size of the sales force, number of employees, size of their marketing budget, have they done marketing before, prior purchases, product purchase correlation, and/or any other measure. These measures may take advantage of publicly available databases the system can pull in to create models around them. The system modeling can determine importance by creating an efficacy model that may target a company.

In some embodiments, the system may identify who is within a particular department of a targeted company to sell to. It can be an aggregation of individuals. The system may model the companies to break them out into cohorts, then taking a statistically significant sample of a hold back group, exposing them to the full paid 510, owned 520, and earned 530 messaging, using the system's methodology, but holding out that group. Then, in some embodiments, the system measures the impact along the parameters to show impact of the marketing.

In some embodiments, measuring the impact of a particular person may not necessarily mean that they are a senior individual. The impact measurements could identify anyone who other people within the company trust for some reason and who leads the company's decisions on a subject.

In some embodiments, information down to the individual user level is knowable. But it can get more restrictive. For example, getting too specific may make it harder to track those users across multiple touch points. As such, in some embodiments, the system might identify them on email, but not other ways. In some embodiments, when the system expands to the company the mosaic expands. The system may recognize a group of individuals in a particular circle. One of the insights incorporated in some embodiments of the system is to let go of the individuals and go for the group because it provides so many benefits. Groups can roll up more signal and aggregating that signal may create the mosaic. Aggregation can let the system connect activities across different touch points which are otherwise in silos. The system may aggregate data from LinkedIn, websites, and/or other sources otherwise too sparse to provide benefit. However, some embodiments may find benefit to dig back into the individual data on one of those channels.

In some embodiments, the abstraction level after pooling data together is unique. The system may target a group of people within a company, for example within a particular department of that company, and try to deliver a message to them, and then track the efficacy of that group relevant to other groups the system may hold out as separate from other groups. The system may use business-to-business models and/or business-to-consumer models.

Some embodiments utilize out of home advertising. Out of home advertising can include billboards alongside the highway, phone booth size billboards on the streets, and/or screens inside elevators. The system may use one of the following methods, or any other method to target those. For example, one method can be to target companies directly. The system may determine the addresses of the offices of these companies and the geographies the system targets and creates a map of the digital out of home screens near those companies. The system may show ads with a targeted message for those companies on screens that surround that company, in their elevators, and/or outside their offices. The system may also, or in addition, target more rural areas on digital screens in the same or different manner than those in a city. People who work in a target corporate headquarters may drive past a billboard every day. The system may target a screen based on knowing about employees. The system may not be targeting any specific individual. The system may focus on the company level and recognize that these advertisements expose the people at that company to a message. The system may see the behavior of that company and connect cause and effect.

In some embodiments, data may also connect individuals, and their respective companies, based on the devices they carry. Perhaps their devices were in the viewing range of the screen when an ad was shown based for instance on a cellphone in a pocket in the elevator of the building. The system can take that data and match it up. Then the system can take that data and further match it to the company level, and then recognize that people who work at a particular company were exposed to these ads. The system can then display such data and results on a dashboard. All of this data analysis may comply with privacy regulations or other policies.

In other embodiments, data and aggregations of data can be shown on a map to display the geographic location of impact, effect, targets, or advertising.

In some embodiments, a report shows three steps. Other embodiments can include other numbers of steps. The system can identify target accounts, for example, at the top of this worksheet, mapping them to the accounts. The system may also have an engage step, which may be the brief, and/or a calendar. On the right side (or elsewhere) may be a campaign report. The interest database may include advertising bid opportunity data. Many companies provide a “demand side platform” to facilitate the buying of advertisements on the web. The entire web browse behavior of an advertising system may contain all the bidding data that's available on the web. This data can be part of a demand side platform. The interest database may derive its data and/or conclusions from analysis or ingestion of demand side platform data. In some embodiments, the system can use advertising data identifying millions of buying opportunities per second, and each one of them may come with a URL and an ID. The system can use the ID and the reference to the browsed web page to identify the content of that web page, the keywords of that page, and how those details may be related to the keywords of a client. The system can then link that ID with interest in a particular topic or sets of topics. Additional tools extract real time data from sales or other CRM data. Data may in addition, or alternatively, come from the social graph.

In some embodiments, the system relates the ads that people are seeing to track media exposure. The ads people see may show interest based on the ads that they are being exposed to. The system database can be shared between clients. So instead of just having the data for company A as a client or company B as a client, there may be information that company A knows and company B knows that both benefit from when the system pulls it together. Such comparisons and synergies may be based on both the companies' and end users' permission. For instance, when a person buys a house, they are probably also interested in insurance, which can be coupled. Perhaps the new homeowners are buying a washing machine. In some embodiments, the system database may contain details of these items that can be coupled. Such details may be displayed in reports, possibly in the left column.

In some embodiments, the report may include information related to channel creative approval. For example, such information can be displayed in a middle column of the report or elsewhere. The system can make it easy to get everything approved, set, and run. Another task can be email signatures, making the email signature of the people at the business becomes a medium to expose customers to ads. For example, every time someone from the sales team can send an email out the signature on their email should have a little ad unit.

In some embodiments, the digital out of home mapping tool is creating a map from companies to the point of presence digital screens, something the system can build to make it easier. For each different channel, the system adds capability that makes it easy and workable for business-to-business. The system can also facilitate the business-to-consumer use case. The system may use social techniques and/or advanced TV. That may include showing ads to people who work at a company at home on their TV. For example, the day before a big meeting with a client an executive may be watching a baseball game sees an ad for that company's product. Then they can be primed for the meeting. The same thing can be done for print, and the same thing for audio. For instance, with podcasts, the ads slotted there may target a business-to-business use case.

In some embodiments, the report can include, for example, on the right side, an intelligence report, which may include the engagements people have. A funnel report may put it into the language of the sales team. The sales force may take this and put it within the tools that they already use. In some embodiments, the system takes these reports and pipes them into sales CRM. In some embodiments, the report may include a company lift measurement. The lift measurement may show the hold out groups and modeling of the companies. Lift measurement may be part of the efficacy measurement.

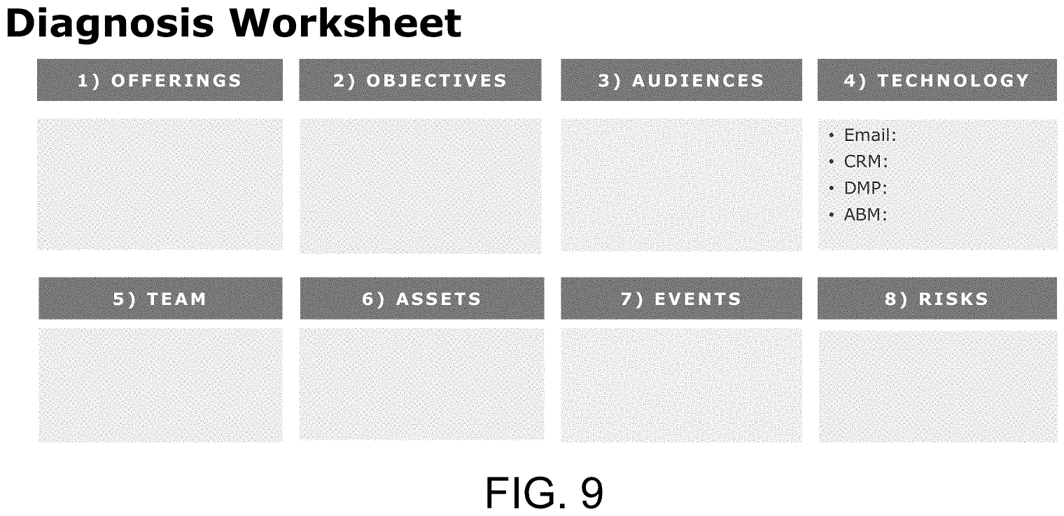

FIG. 9 illustrates potential categories for consideration in one or more embodiments. The initialization of new customers or data sources may evaluate numerous topics. The system may evaluate offerings, objectives, audiences, technology, team members, assets, events, and risks as well as other issues. Technology considerations may include characteristics of the email, Customer Relationship Management (CRM), Data Management Platform (DMP), and Account-Based Marketing (ABM) systems or others.

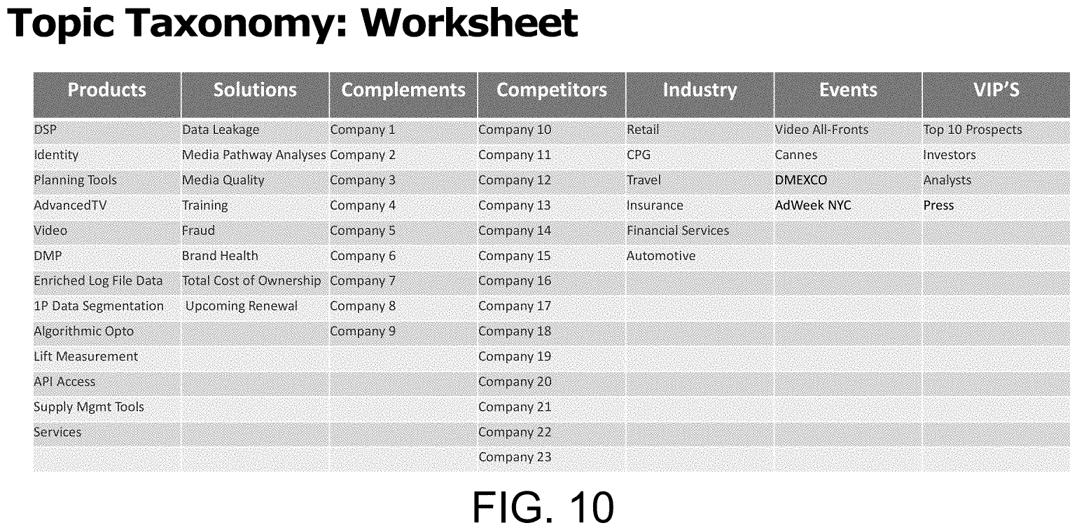

FIG. 10 illustrates a worksheet of data found in one or more embodiments. Diverse data sources may include numerous information categories, such as products, solutions, complements, competitors, industries, events, personnel, including VIPs, and others. Such diverse data sources may be mapped to the systems common data model.

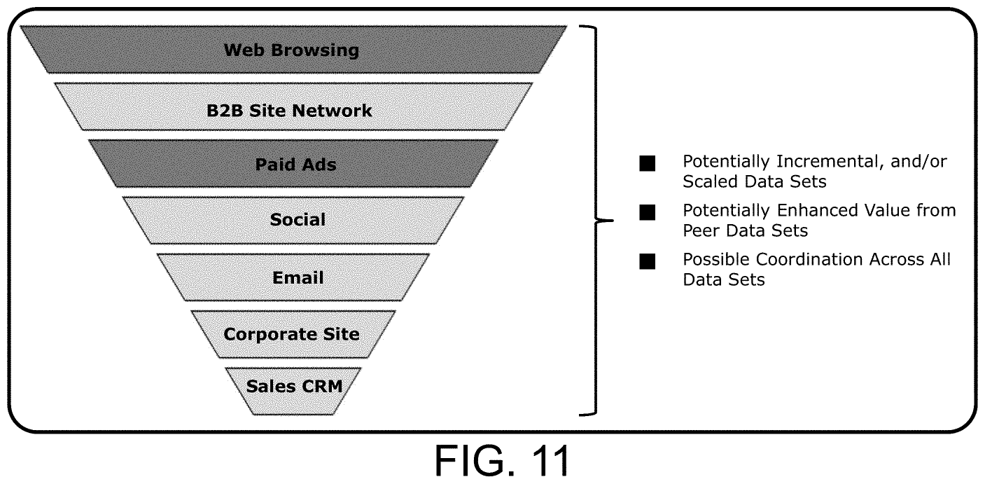

FIG. 11 illustrates possible data used in some embodiments. In some embodiments, data may include web browsing, business-to-business site network data, paid ads, social media posts and/or interaction, email, interaction with and content of corporate sites, sales CRM, and others. Such diverse data sets may be incremental or scaled. The system may derive enhanced value from peer data sets and may coordinate and/or correlate data across sets.

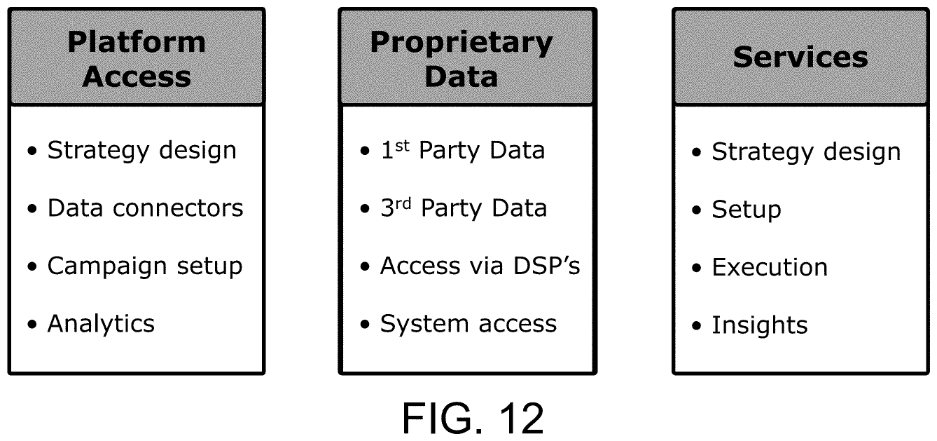

FIG. 12 illustrates possible elements of one or more embodiments. The system may add value to customers via platform access, which may incorporate strategy design, data connectors, campaign setup, and analytics. The system may provide access to proprietary data including customer data or third-party data. Customers may obtain benefits from accessing the system via demand side platforms or directly accessing the system. The system may provide services to enhance business strategy, setup system integrations, execute campaigns, or provide insights or other benefits.

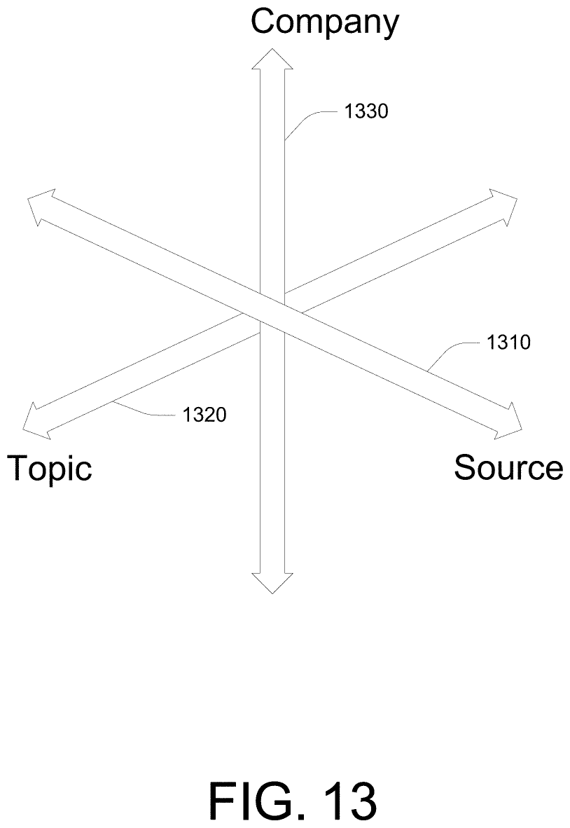

FIG. 13 illustrates three independent variables attached to collected data points according to some embodiments. In some embodiments the system attaches a “topic” 1320 to each engagement. For example, the system would know the topic 1320 of an ad or email that a user (and by linkage company 1330) engaged with. By normalizing across touchpoints too, the system may connect an email click and/or an ad click to a specific product and a specific customer service case. The addition of the third dimension, data source 1310 makes the data not only relevant across departments within a company 1330, but normalized and relevant across companies 1330 so the system can deduce and share insights shareable across companies 1330, such as for example cross-company benchmarks for certain engagement types like ad clicks, by company 1330, industry, or topic 1320.

Interactions between people and electronic resources in a marketing setting are often anonymous. In contrast, when a customer purchases a product or calls support, the company 1330 may be clearly identified. With marketing, when a user clicks an ad, visits a page on a website, or likes a twitter post, their company 1330 affiliation is not always apparent. The system makes connections by normalizing and cross correlating data across all heterogeneous touchpoints. Furthermore, company-identified data may be further refined to identify departments within a company 1330.

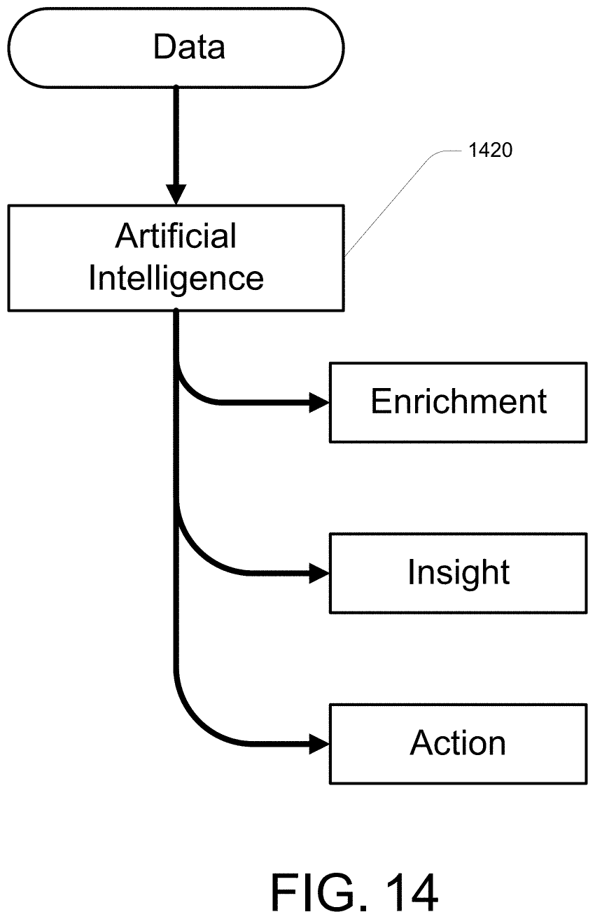

The system may use artificial intelligence 1420 in any of at least the following ways: enrichment, insights, and/or action, according to some embodiments, as illustrated in FIG. 14. Enrichment: when transforming data, the system aggregates from various sources, surfacing three key parameters (source 1310, topic 1320, company 1330) and normalizing the data. For example, a “company” in one source is matched to a “company” from another source. In some cases, all three key parameters are present, but when they are not, artificial intelligence 1420 (AI) at the enrichment step can use other relevant data to fill in the blanks. Such external data sources 1310 that contribute to AI 1420 may include data from business data aggregators, data collected directly from clients, or other means. The system may be able to predict that a new engagement is on the same topic as previous engagements based on AI 1420 analysis of the data in the new and previous engagements.

Insights: the system may offer predictive and anticipatory value. For example, by exposing the AI 1420 to historical data on which prospects have signed up for services and the digital marketing engagements of those prospects in the 6 months leading up to that “business win”, the system can predict what other prospects are likely to sign up based on similar engagement patterns. Such insights may be used by sales teams, or others, to prioritize outreach. AI 1420 driven insights can also identify which digital engagements (what engagement types and what topics) were most correlated to “business wins” to prioritize successful methodologies.

Action: by taking advantage of the enrichment and insight provided by AI 1420, the system can further take advantage of AI 1420 by adjusting campaigns or making other business decisions in departments outside of marketing.

Many companies perform a transformation step on the data they use in their analysis. That layer is often based on heavy manual labor to transform source data.

Some embodiments aggregate data and put it into an internally developed data structure, which may be identified as a common data model. This process only requires understanding and transforming the data once. Such transformation may use SQL, or related tools such as dbt, which allow data scientists to connect the dots with all this data, build in business rules using data from different sources, and define how data should interact. Each data source 1310 may have its own data model. However, mapping the source data model to the system's internal model only needs to happen once.

The common data model allows information from disparate sources to be correlated and merged. Doing the transformation process just once creates a standardization and normalizes the data across all companies and sources allowing benchmarks and metrics that cross over numerous business objectives. The system enhances the traditional vertical transformation, in a sense a transformation plus, doing more than just connecting the dots across sources.

In some embodiments the system is a complex network of data sources 1310, data mapping, transformation, business logic and embedded partnerships. Once the data is connected and modeled, the system may provide an interface to connect external tools to leverage the fully integrated data from the system or use the system's native business intelligence (BI) interface. External BI tools may include tools such as Tableau, Datorama, or Looker. In addition to connecting external tools to the system, the system can push the data directly into business applications like Salesforce, Outreach, JIRA, Netsuite, or others.

Enrichment may include adding additional data not available in the original data set by bringing in third party data and making it easy for companies to provide their own data. All these sources may be correlated and compared to create insights. Using a common model allows common visualization layers to intuitively understand the data. Additional client sources may include data from marketing, sales, and/or product management tools. Third party sources could include sources such as Dun & Bradstreet, social media sites, or another intermediate data aggregator.

The presence of diverse data enables artificial intelligence 1420 to contribute to understanding, categorizing, and transforming data. A machine learning model can infer that new data is like a previously seen source and/or type of data. For example, newly acquired data may seem like data known to come from LinkedIn and the artificial intelligence 1420 may deduce the new source is also from LinkedIn. Such inferences can speed the adaptation of new data sources 1310.

The system's data model may also allow artificial intelligence 1420 to draw the insights and make recommendations. Machine learning allows taking data, processing it, and then making predictions based on inferred correlation. In a sales context that could identify sales prospects that positively closed and identify similar prospects likely to result in successful sales.

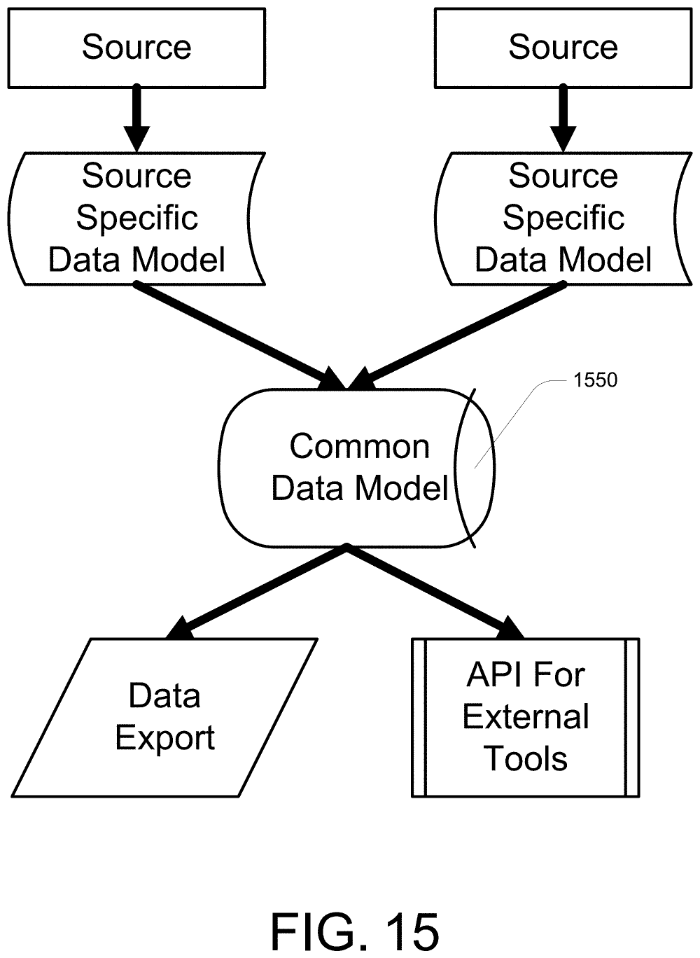

FIG. 15 shows the conversion of source specific data models to a common data model 1550, according to some embodiments. Each source 1310 may have its own data model for storing and presenting data. In addition to differences in data models, different sources may have different ontologies, wherein they use the same terms but give those terms different meaning. The system must ingest and process data from a plurality of sources and data models. In some embodiments, the system uses a common data model 1550 to represent data from the plurality of sources. A transformation step is required to convert data from a source using the source specific data model into the common data model 1550. Generally, the creation of this transformation step must only be done once for each source. In some cases, the system must adjust the transformation because of a change in a source's data model. In some embodiments the system makes use of the common data model 1550 both to store information and facilitate analysis and processing. The use of a common data model 1550 enables both data export and external data access. In some embodiments, the common data model 1550 may be simpler than the source data models. However, that increased simplicity may enhance the ability to connect and correlate data between sources which would otherwise not be comparable due to their complex and divergent data models. The common data model 1550 usually includes at least source 1310, topic 1320, and company 1330, as illustrated in FIG. 13. Data stored in the system using the common data model 1550 may be exported in a form convenient for importing into other tools or databases. Such databases may include CRM software, as but one example. In addition to data export, a common data model 1550 allows the system in some embodiments to expose a well-defined API for external tools to access the data stored in the system. Visualization tools, such as Tableau, or other external tools may therefore take advantage of the common data view provided by the common data model 1550.

The system may generate the needed connections between data. Raw data from a source may be transformed using dynamically generated and optimized SQL or other data source querying languages.

According to some embodiments, the system comprises one or more computer readable storage devices storing computer executable instructions and one or more computer processors configured to execute the computer executable instructions.

According to some embodiments, the system generates a first company profile by receiving information from a plurality of sources, where each source comprises data associated with individuals. The source information may comprise at least a first data item associated with a first individual from a first data source and a second data item associated with a second individual from a second data source, the first data source having a first data model, the second data source having a second data model, where the first and second data models are different. The system may also map the information from the plurality of sources to a common data model 1550 comprising datapoints with each of a data source 1310, a topic 1320, and a company 1330. The system may associate a first topic with the first data item and a second topic with the second data item, wherein the first topic and the second topic are elements of a database of topics available to the system. The system may affiliate the first individual with a first company and the second individual with a second company where the first company and the second company are elements of a database of companies available to the system. The system may associate the first data item with the first company and associates the second data item with the second company. The system may aggregate information from the plurality of sources having the company set to the first company.

According to some embodiments, the system may use the first company profile to target the first company by receiving the first company as a target for a business interaction, identifying the first topic as a relevant factor for targeting the first company, incorporating insight from the first company profile into the business interaction, and monitoring the plurality of sources for evidence of the business interaction based on the first company profile. The system may also evaluate the effectiveness of the business interaction, where the evaluation is based at least in part on the first company profile and on the evidence of the business interaction. The system may update the first company profile based at least in part on the evidence of the business interaction.

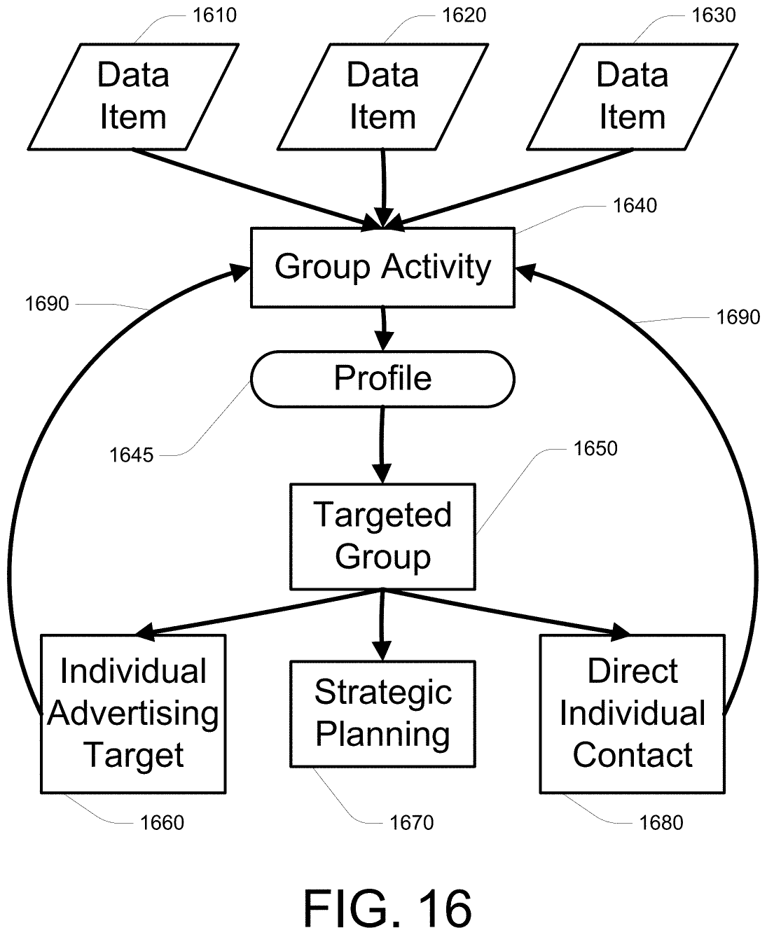

FIG. 16 is a flowchart of system operation, according to some embodiments. From a plurality of data sources come data items 1610, 1620, and 1630. Each data source 1310 may have different types of data and use a different data model to represent transactional or aggregated information. Each data item may contain diverse fields, but at least some of the fields relate to an identifiable subject of the data.

The system may adapt the diverse data models of the data sources and store information in a common data model 1550. That model may use the triplet of data source 1310, topic 1320, and company 1330 as a key identifier. To attach such an identifier to incoming data items 1610, 1620, 1630, the system must map the subjects of the source data to the companies they represent. The linkage between individuals may be explicit, such as when another data source 1310 such as LinkedIn provides a direct linkage between an individual identifier and a company 1330 affiliation. The linkage may also be inferred based on common patterns between an individual data item subject and other company 1330 affiliations. Indirect linkages are common when interacting with web resources since many activities are anonymous. The system may have to create multiple layers of links between an electronic transaction record, the person behind the keyboard, and ultimately the company 1330 or organization that person represents. Over time the mapping between individuals and companies may change and data points may be mapped to the company 1330 an individual was affiliated with at the time. A change in individual affiliation does not change the past associations and historical data remains connected to the company 1330 the individual was affiliated with at the time of data collection. The mapping from raw data to company 1330 may be performed by artificial intelligence 1420.

Topics may be related to keywords, or key ideas and provide a subject matter designation for data, transactions, or aggregate information. Artificial intelligence 1420 may assign topics to a data item based on the data source 1310, subjects of the data item, patterns of behavior or data commonalities, or any other basis the AI 1420 determines is justified by existing data.

By using data items 1610, 1620, 1630 and the generated mapping to the triple key of a data source 1310, topic 1320, and company 1330, the actions of individuals or groups may be affiliated with a group and the individual actions may be aggregated to represent group activity 1640. In many instances businesses desire to interact with and sell products to other businesses. The ability to focus on this group activity 1640 can enhance business to business marketing and other inter-business interactions.

The consolidation of group activity 1640 by company 1330 may allow the system to create company profiles 1645. A company profile may include the data points attributed to that company 1330 as well as additional raw data about the company 1330, aggregated data about the company 1330 from third-party sources, and/or system generated information about the company 1330. Such a company profile 1645 allows the system to treat the company 1330 as a first-class entity. Such an entity may be monitored, tracked, interacted with, and analyzed for business purposes.

Using a company profile 1645, the system may target a particular group. A targeted group 1650 may be a company 1330 as a whole or a portion of a company 1330. Large companies may reasonably be treated by the system as a related set of smaller units so that analytics and profiles may be differentiated between business units. The system may receive target companies. The system may also receive the selling points of products. Selling points may be converted by the system into keywords and/or topics. When receiving selling points of products, the system may generate a list of one or more companies to target based on the use of the topics related to the product and the company profiles 1645 generated by the system. The system may use artificial intelligence 1420 to generate topics and keywords based on product features and/or selling points. Artificial intelligence 1420 may also identify target companies. Once the system identifies a targeted group 1650 multiple possible actions are possible. In some embodiments, the system may estimate the likelihood of success of various actions and/or propose recommended actions.

Actions may include targeting an individual advertising target 1660, informing strategic planning 1670, directly contacting an individual 1680, or numerous other actions described herein or known to the marketing industry. Actions related to the targeted group 1650 may be taken singly or in combination. The targeted group 1650 may have different characteristics from any of the individuals leading to the company profile 1645. An individual advertising target 1660, for instance, is not necessarily an individual associated with any data items 1610, 1620, 1630 that contributed to the group activity 1640 and the company profile 1645. Some reasons the targeted individual 1660 may not have contributed data points may include that they are not active in electronic forums where data may be collected, or perhaps they are newly affiliated with a company 1330, or perhaps the system has determined that an individual not directly affiliated with a target company may be an influencer and thereby affect the company's purchases, or some other reason.

The insights provided by the system may contribute to strategic planning 1670. The metrics and knowledge of how, what, when, and where a company 1330 makes purchases may guide business planning and other decisions. Insights may also identify trends in company 1330 needs or expose emerging opportunities. In more immediate actions, insights from the system based on the company profile 1645 and a targeted group 1650 may identify individuals to contact. Sales or marketing personnel may use the guided direct individual contact 1680 provided by the system to prioritize outreach or follow up efforts.

Any actions towards a targeted group 1650 may result in a business interaction, including events such as individual advertising 1660 or direct individual contact 1680. The system may monitor such interactions as well as follow up activities of both the targeted individuals as well as other company affiliates to evaluate the success of the interaction. For example, the person at a company 1330 that makes a purchase may not be the same person directly contacted but may have influenced the outcome. Executives may approve purchases recommended by other employees or direct action and leave the purchasing decisions to others. Different companies may have various behavioral models and the company profile 1645 may include insight into how a company 1330 behaves and what actions toward a targeted group 1650 are most likely to succeed. The feedback loop 1690 that connects actions toward a targeted group 1650 to future group activity 1640 may enhance the company profile 1645 and further refine the insights available from the system.

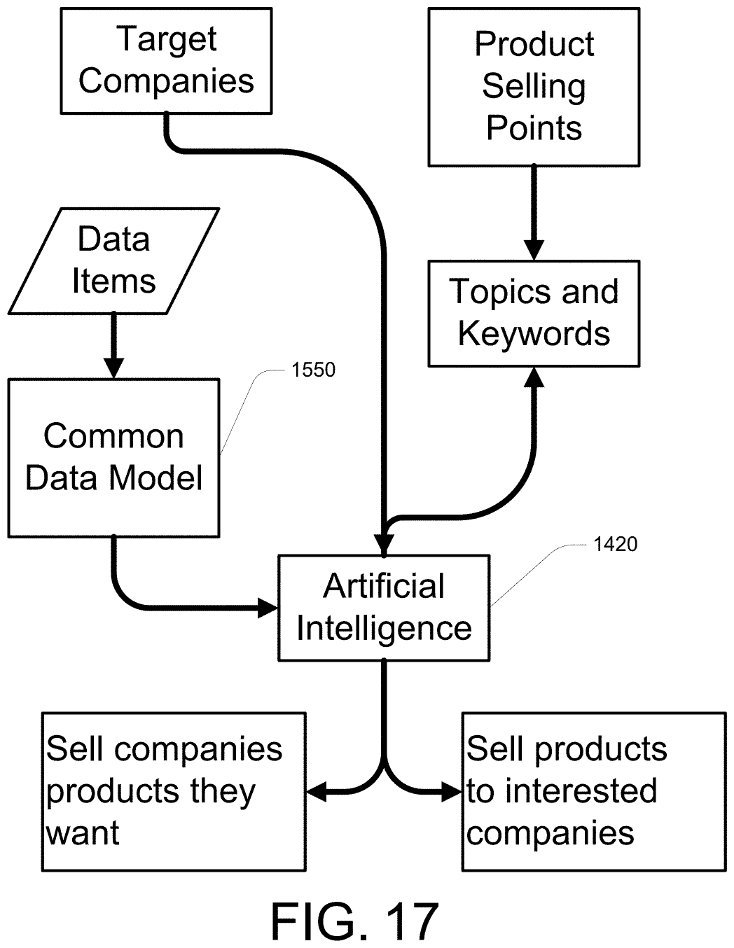

FIG. 17 shows steps the system may take to cause product sales, according to some embodiments. The system may receive product selling points from a company 1330 interested in selling its products. The system may either use provided topics and keywords, or generate topics and keywords based on the product selling points. Artificial intelligence 1420 may generate the topics and/or keywords based on the selling points. In some embodiments the system maintains its own database of topics.

In some embodiments the system either receives a list of target companies or uses artificial intelligence 1420 to generate a list of target companies. The combination of target companies and product selling points together create a set of possible buyers and a set of possible products to purchase.

Data items from a plurality of data sources 1310 may be transformed and loaded into a common data model 1550 and repository. This common data model 1550 provides an input to artificial intelligence 1420 processing of information in the system in some embodiments. The common data model 1550 may use the source 1310, topic 1320, and company 1330 components illustrated in FIG. 13 to equate the topics and/or keywords related to the product selling points to topics in the common data model 1550.

With the input of artificial intelligence 1420, clients with products to sell may identify interested buyers. Also, clients targeting companies may identify the products and services needed by those target companies. In both cases, the system may contribute to the business-to-business transactions that benefit both parties.

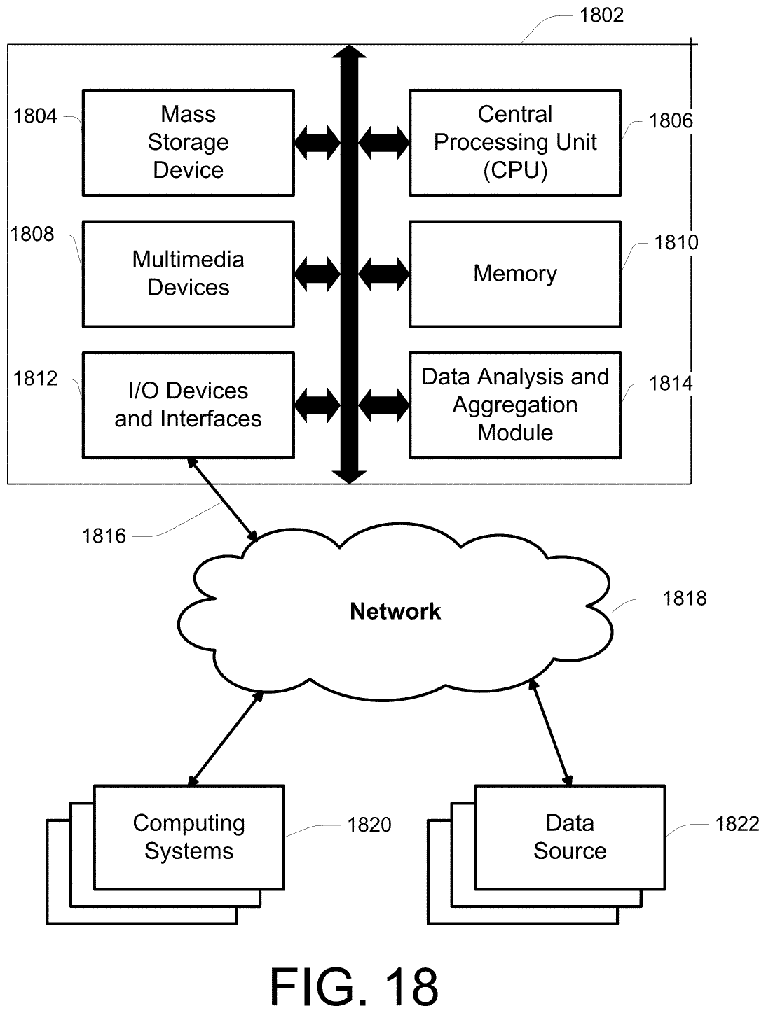

FIG. 18 is a block diagram depicting an embodiment(s) of a computer hardware system configured to run software for implementing one or more embodiments of systems, methods, and devices for analysis and aggregation of data from disparate data platforms.

In some embodiments, the systems, processes, and methods described herein are implemented using a computing system, such as the one illustrated in FIG. 18. The example computer system 1802 is in communication with one or more computing systems 1820 and/or one or more data sources 1822 via one or more networks 1818. While FIG. 18 illustrates an embodiment of a computing system 1802, it is recognized that the functionality provided for in the components and modules of computer system 1802 can be combined into fewer components and modules, or further separated into additional components and modules. The data sources 1822 connected via one or more networks 1818 may equate to the data sources 1310 used in the common data model 1550.

The computer system 1802 can comprise a data analysis and aggregation module 1814 that carries out the functions, methods, acts, and/or processes described herein. The data analysis and aggregation module 1814 is executed on the computer system 1802 by a central processing unit 1806 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted. The computer system 1802 includes one or more processing units (CPU) 1806, which can comprise a microprocessor. The computer system 1802 further includes a physical memory 1810, such as random access memory (RAM) for temporary storage of information, a read only memory (ROM) for permanent storage of information, and a mass storage device 1804, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 1802 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1802 includes one or more input/output (I/O) devices and interfaces 1812, such as a keyboard, mouse, touch pad, and printer. The I/O devices and interfaces 1812 can include one or more display devices, such as a monitor, that allows the visual presentation of data to a user. More particularly, a display device provides for the presentation of GUIs as application software data, and multi-media presentations, for example. The I/O devices and interfaces 1812 can also provide a communications interface to various external devices. The computer system 1802 can comprise one or more multi-media devices 1808, such as speakers, video cards, graphics accelerators, and microphones, for example.

The computer system 1802 can run on a variety of computing devices, such as a server, a Windows server, a Structure Query Language server, a Unix Server, a personal computer, a laptop computer, and so forth. In other embodiments, the computer system 1802 can run on a cluster computer system, a mainframe computer system and/or other computing system suitable for controlling and/or communicating with large databases, performing high volume transaction processing, and generating reports from large databases. The computing system 1802 is generally controlled and coordinated by an operating system software, such as z/OS, Windows, Linux, UNIX, BSD, PHP, SunOS, Solaris, MacOS, ICloud services or other compatible operating systems, including proprietary operating systems. Operating systems control and schedule computer processes for execution, perform memory management, provide file system, networking, and I/O services, and provide a user interface, such as a graphical user interface (GUI), among other things.

The computer system 1802 illustrated in FIG. 18 is coupled to a network 1818, such as a LAN, WAN, or the Internet via a communication link 1816 (wired, wireless, or a combination thereof). Network 1818 communicates with various computing devices and/or other electronic devices. Network 1818 is communicating with one or more computing systems 1820 and one or more data sources 1822. The data analysis and aggregation module 1814 can access or can be accessed by computing systems 1820 and/or data sources 1822 through a web-enabled user access point. Connections can be a direct physical connection, a virtual connection, and other connection type. The web-enabled user access point can comprise a browser module that uses text, graphics, audio, video, and other media to present data and to allow interaction with data via the network 1818.

The output module can be implemented as a combination of an all-points addressable display such as a cathode ray tube (CRT), a liquid crystal display (LCD), a plasma display, or other types and/or combinations of displays. The output module can be implemented to communicate with input devices 1812 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module can communicate with a set of input and output devices to receive signals from the user.

The computing system 1802 can include one or more internal and/or external data sources (for example, data sources 1822). In some embodiments, one or more of the data repositories and the data sources described above can be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 1802 can also access one or more databases 1822. The databases 1822 can be stored in a database or data repository. The computer system 1802 can access the one or more databases 1822 through a network 1818 or can directly access the database or data repository through I/O devices and interfaces 1812. The data repository storing the one or more databases 1822 can reside within the computer system 1802.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Doman Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, and so forth. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, and so forth.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

What is claimed is:

1. A computer system comprising:
one or more computer readable storage devices storing computer executable instructions; and
one or more computer processors in communication with the one or more computer readable storage devices and configured to execute the computer executable instructions to cause the computer system to:
generate a first company profile by:
receiving information from a plurality of sources, wherein each of the plurality of sources comprises at least one data item associated with at least one of a plurality of individuals, wherein the information comprises at least a first data item associated with a first individual from a first data source and a second data item associated with a second individual from a second data source, the first data source having a first data model, the second data source having a second data model, wherein the first data model and the second data model are different;
mapping the information from the plurality of sources to a common data model comprising datapoints with each of a data source, a topic, and a company;
associating a first topic with the first data item and a second topic with the second data item, wherein the first topic and the second topic are elements of a database of topics accessible by the system;
affiliating the first individual with a first company and the second individual with a second company wherein the first company and the second company are elements of a database of companies accessible by the system;
associating the first data item with the first company and associating the second data item with the second company;
aggregating information from the plurality of sources having the company set to the first company;
use the first company profile to target the first company by:
receiving the first company as a target for a business interaction;
identifying the first topic as a relevant factor for targeting the first company;
incorporating information from the first company profile into the business interaction;
monitoring the plurality of sources for evidence of the business interaction based on the first company profile;
evaluating an effectiveness of the business interaction, wherein the evaluation of the effectiveness of the business interaction is based at least in part on the first company profile and on the evidence of the business interaction;
updating the first company profile based at least in part on the evidence of the business interaction.

2. The computer system of claim 1 wherein the mapping from each individual affiliated with the company to the company may change over time wherein a particular individual may be affiliated with the first company at one time and may be affiliated with the second company at a later time.

3. The computer system of claim 1 wherein the mapping of individuals to companies is performed by an artificial intelligence system based at least in part on the information from the plurality of sources.

4. The computer system of claim 3 wherein associating the first topic with the first data item is performed by the artificial intelligence system based at least in part on the information from the plurality of sources.

5. The computer system of claim 4 wherein the system receives the first topic as relevant to the purpose of the business interaction and the artificial intelligence system identifies the first company as the target for the business interaction.

6. The computer system of claim 1 further comprising an artificial intelligence system configured to predict a likelihood the business interaction with a company will be effective based at least in part on the company profile and a set of historical data about the company.

7. The computer system of claim 1 wherein the plurality of data sources comprise data items from a plurality of paid, owned, and earned sources.

8. The computer system of claim 1 further comprising an application programming interface allowing an external program to access the information from the plurality of sources in the common data model.

9. The computer system of claim 1 further comprising a user interface to display the information from the plurality of sources in the common data model.

10. The computer system of claim 9 further comprising a report displayed on the user interface including information from the first company profile and the effectiveness of the business interaction.

11. The computer system of claim 9 further comprising a report displayed on the user interface comparing a plurality of company profiles and summarizing the data items from the plurality of paid, owned, and earned sources.

12. A method for enhancing business to business marketing, the method comprising:
by one or more computer processors executing computer executable instructions:
generating a first company profile by:
receiving information from a plurality of sources, wherein each of the plurality of sources comprises at least one data item associated with at least one of a plurality of individuals, wherein the information comprises at least a first data item associated with a first individual from a first data source and a second data item associated with a second individual from a second data source, the first data source having a first data model, the second data source having a second data model, wherein the first data model and the second data model are different;
mapping the information from the plurality of sources to a common data model comprising datapoints with each of a data source, a topic, and a company;
associating a first topic with the first data item and a second topic with the second data item, wherein the first topic and the second topic are elements of a database of topics accessible by to the system;
affiliating the first individual with a first company and the second individual with a second company wherein the first company and the second company are elements of a database of companies accessible by to the system;
associating the first data item with the first company and associating the second data item with the second company;
aggregating information from the plurality of sources having the company set to the first company;
using the first company profile to target the first company by:
receiving the first company as a target for a business interaction;
identifying the first topic as a relevant factor for targeting the first company;
incorporating information from the first company profile into the business interaction;
monitoring the plurality of sources for evidence of the business interaction based on the first company profile;
evaluating an effectiveness of the business interaction, wherein the evaluation of the effectiveness of the business interaction is based at least in part on the first company profile and on the evidence of the business interaction;
updating the first company profile based at least in part on the evidence of the business interaction.

13. The method of claim 12 wherein the mapping from each individual affiliated with the company to the company changes over time wherein a particular individual affiliated with the first company at one time is affiliated with the second company at a later time.

14. The method of claim 12 wherein the mapping of individuals to companies is performed by an artificial intelligence system based at least in part on the information from the plurality of sources.

15. The method of claim 14 wherein associating the first topic with the first data item is performed by the artificial intelligence system based at least in part on the information from the plurality of sources.

16. The method of claim 15 wherein the artificial intelligence system identifies the first topic as relevant to the purpose of the business interaction and the artificial intelligence identifies the first company as the target for the business interaction.

17. The method of claim 12 further comprising an artificial intelligence system predicting a likelihood the business interaction with a company will be effective based at least in part on the company profile and a set of historical data about the company.

18. The method of claim 12 further comprising sending the information from the plurality of sources in the common data model to an external program via an application programming interface.

19. The method of claim 12 further comprising displaying the information from the plurality of sources in the common data model.

20. The method of claim 19 further comprising generating a report including information from the first company profile and the effectiveness of the business interaction.
